(19) United States
(12) Patent Application Publication
(10) Pub. No.: US 2008/0092444 A1
(43) Pub. Date: Apr. 24, 2008

(54) Rotating shaft of shutter louver

(76) Inventor: Fu-Yung Yang, Dongguan City (CN)

Correspondence Address: RABIN & Berdo, PC, 1101 14TH STREET, NW, SUITE 500, WASHINGTON, DC, 20005, US

(21) Appl. No.: 11/505,297

(22) Filed: Aug. 17, 2006

(51) Int. Cl. E06B 7/084

(52) U.S. Cl. 49/92.1

(57) ABSTRACT

A rotating shaft of a shutter louver is provided, which is inserted into a louver mounting hole and frame mounting hole, so as to connect the louver to the frame. The rotating shaft is formed by a shaft bushing and shaft, wherein a shaft hole is formed through the body of the shaft bushing, a flange is disposed on the body and a gripping portion is protruded from the body. The shaft is accommodated within the shaft hole, and a fin is protruded from the shaft tail. When the rotating shaft is inserted into the frame mounting hole, the gripping portion is used to bear against the inner side of the frame mounting hole and thereby applying a force to grip the rotating shaft, and cooperating with the operation of gripping the louver mounting hole by the fin, the louver is positioned on the frame quickly and firmly.

### BACKGROUND OF THE INVENTION

1. Field of Invention

The present invention relates to a rotating shaft of a shutter louver, and more particularly, to a rotating shaft of a shutter louver, which utilizes a gripping portion protruded from the outer edge of the shaft bushing to cooperate with a fin disposed on the shaft tail to pivotally connect the louver and position the louver on the frame.

2. Related Art

Current shutter or louvered windows always have a plurality of louvers thereon for adjusting the airflow and the light. Generally, a rotating shaft is disposed between the louvers and the frame of the shutter, so as to position the louvers on the frame. However, the rotating shaft always cannot be used to avoid getting loose caused by the rotation of the louver, thus, some necessary designs are made on the shaft to prevent the loosening circumstance from occurring again, and most of the common rotating shafts are just like the one disclosed in U.S. Patent Publication NO. 5,630,295.

Referring to FIG. 1, it shows a rotating shaft of a shutter disclosed in U.S. Patent Publication NO. 5,630,295. The louver of the shutter is fixed on the frame of the shutter, a frame mounting hole is opened on the frame of the shutter, and louver mounting holes are also opened at the shaft center of the louver of the shutter. The rotating shaft comprises a pivot 120 and a cylindrical shaft bushing 110 sleeved on the pivot 120. The pivot 120 itself is formed by a pivot front end 121, a pivot middle section 122 and a pivot back end 123 with their shaft diameters sequentially from small to large, and the outer edge of the pivot middle section 122 has a thread 1221. The cylindrical shaft bushing 110 is formed by a frame 112 and a cylindrical shaft barrel 111 with a through hole, wherein the frame 112 is disposed at the back end of the cylindrical shaft barrel 111, and the outside diameter of the frame 112 is larger than that of the cylindrical shaft barrel 111, and a plurality of shaft bushing wings 113 is disposed on one side edge of the cylindrical shaft barrel 111.

When the cylindrical shaft bushing 110 is sleeved on the pivot 120, the pivot middle section 122 passes through and is accommodated within the cylindrical shaft barrel 111, and the pivot back end 123 bears against the outer edge of the front end of the cylindrical shaft bushing 110, and the thread 1221 of the pivot middle section 122 produces a gripping force with the inner side of the cylindrical shaft barrel 111, thus fixing the pivot 120 within the cylindrical shaft bushing 110. When the cylindrical shaft bushing 110 is inserted into the frame mounting hole, the shaft bushing wing 113 is gripped to the inner side of the frame mounting hole, so as to fix the cylindrical shaft bushing 110 on the frame of the shutter, and the front end 121 of the pivot 120 is inserted into the louver mounting hole, thereby positioning the louver of the shutter on the frame of the shutter.

But this mounting way has the unavoidable disadvantages as follows:

(1) The shaft bushing wing is easily damaged. Generally, the shaft bushing wing is sheet-shaped or strip-shaped, and its cross-sectional view is bar-shaped and quite small in width. When the aperture of the frame mounting hole is excessively close to the outside diameter of the cylindrical shaft bushing that the cylindrical shaft bushing cannot be inserted into the frame mounting hole, the cylindrical shaft bushing is forced into the frame mounting hole by pressing, thus the shaft bushing wing is damaged, deformed, or cracked in shape due to the excessive large pressure or the counterforce from the inner side of the frame mounting hole that cannot be born any more, so that the cylindrical shaft bushing cannot be fixed in the frame mounting hole. Moreover, as the rotation of the louvers, the damaged and deformed shaft bushing wing continuously rub with the inner side of the frame mounting hole, thus, the aperture of the frame mounting hole is continuously enlarged.

(2) The aperture of the frame mounting hole is changed due to the variation of the climate, so that the cylindrical shaft bushing cannot be inserted or fixed therein. Generally, most of the shutters or louver windows are made of wood that easily varies obviously due to the heat expand and cold contract caused by the weather, temperature, and humidity, and thus, the size of the aperture of the frame mounting hole is changed accordingly. When it is hot, the aperture contracts, thus the rotating shaft is difficult to be inserted, and the pressure towards the inserted rotating shaft has gradually become larger, thus the shaft bushing wing is easily deformed; When it is cold, the aperture expands, such that the maximum outside diameter is generally insufficient, and the shaft bushing wing cannot bear against the inner side of the frame mounting hole to firmly lock the rotating shaft within the frame mounting hole, so that the louver cannot be positioned on the frame.

(3) It is difficult to be detached. If the pivot of the rotating shaft or the cylindrical shaft bushing is damaged due to some reasons, for example, when it is intended to detach the rotating shaft since the pivot is deformed or the shaft bushing wing is cracked as a result of applying a force improperly, the rotating shaft is generally difficult to be detached due to the excessive large gripping force produced between the thread and the inner side of the cylindrical shaft barrel, and thereby all the means for the rotating shaft have to be changed.

### SUMMARY OF THE INVENTION

In view of the above, the main technology problem to be solved by the present invention is to provide a rotating shaft of a shutter louver, wherein a gripping portion used for bearing against the frame mounting hole is disposed on the shaft bushing, so as to produce a force for gripping the rotating shaft on the frame, and a fin is disposed on the tail of the rotating shaft to strengthen the positioning of the louver on the frame, and the rotating shaft of the shutter louver can be detached easily and securely.

The present invention provides a rotating shaft of a shutter louver, which is mainly used to connect and position the louver of the shutter on the frame of the shutter. The rotating shaft is formed by two structures of a shaft bushing and a shaft. The shaft bushing comprises a body, a flange, and a plurality of gripping portions. A shaft hole passes though the front and back ends of the body, and the flange is disposed at the outer edge of the back end of the body, and each gripping portion is protruded from the outer edge of the middle section of the body, and symmetrically about the shaft center of the body. Each protruded gripping portion has two ramps, and the upper sides of the two ramps are connected to form a top edge, and the lower sides of the ramps are spaced apart for a predetermined distance and respectively connected to the outer edge of the body. From the cross-sectional view, the gripping portion is wedge-shaped.

The shaft comprises three parts: a shaft head, a shaft middle section, and a shaft tail with their outside diameters sequentially from large to small. The shaft is inserted into the shaft hole from the shaft head, and the shaft body passes through and is accommodated within the shaft hole, wherein the outside diameter of the shaft head is larger than that of the shaft hole, so that when the shaft is inserted into the shaft bushing, the shaft bears against the front end of the shaft bushing and the outer edge of the shaft hole. The outside diameter of the shaft middle section is between the outside diameter of the shaft head and that of the shaft tail, but a little smaller than the aperture of the shaft hole, and a fin is protruded from the outer edge of the shaft tail.

A frame mounting hole is opened on the frame, and its aperture is limited to a size that is very close to the outside diameter of the shaft bushing. When the shaft bushing and the shaft are combined into a rotating shaft, the shaft bushing is inserted into the frame mounting hole, and at this time, the top edge of each gripping portion of the shaft bushing bears against the inner side of the frame mounting hole, so as to form a force for gripping the shaft bushing, and thereby firmly positioning the rotating shaft on the frame. Meanwhile, the wedge-shaped structure of the gripping portion is utilized to transfer the counterforce produced by the top edge bearing against the inner side of the frame mounting hole outwards via the ramp, and finally, the above two forces are counteracted, thus making the whole supporting force form a balance. If the shape of the shaft head is further formed into a streamline shape corresponding to that of the gripping portion, such as a semi-circular shape or a polygonal column shape with a trapezoidal cross-section, the supporting force exerted by the rotating shaft to the frame mounting hole is further enhanced.

A louver mounting hole with its aperture close to the size of the shaft tail is also opened on the louver. When the rotating shaft is pivotally connected to the louver, i.e., the shaft tail is inserted into the louver mounting hole, the fin is utilized to bear against the outer edge of the louver mounting hole, so as to enhance the effect of fixing the rotating shaft on the louver. Using the two fixing methods together can quickly position the louver on the frame, and thus, the loosening circumstance of the rotating shaft due to the rotation of the louver never occurs.

In view of the above, the present invention utilizes a wedge-shaped gripping portion to bear against the inner side of the frame mounting hole, so as to form a force for gripping the rotating shaft, and when the louver rotates, the plurality of gripping portions bear towards the same direction, so as to form a plurality of counterforce to bear against the rotating shaft at the same time, thus gripping the rotating shaft to avoid loosening or rotating optionally. Next, the ramp of the gripping portion detracts the counterforce produced by the top edge of the gripping portion bearing against the inner side of the frame mounting hole, and the shaft head is designed into a streamline shape for matching with the shaft bushing, so that the rotating shaft produces a larger supporting force to the frame, thereby preventing the rotating shaft from being deformed due to an external force, so as to provide a preferred way of positioning the shutter louver.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of the conventional art;

FIG. 2A is a structure diagram of components according to a first embodiment of the present invention;

FIG. 2B is a cross-sectional view of a shaft bushing according to the first embodiment of the present invention;

FIG. 3A is a side view of the shaft bushing according to the first embodiment of the present invention;

FIG. 3B is a front view of the shaft bushing according to the first embodiment of the present invention;

FIG. 4 is an assembly view of a rotating shaft according to the first embodiment of the present invention;

FIG. 5A is a mounting diagram of components of a shutter according to the first embodiment of the present invention;

FIG. 5B is a cutaway view of the connection of the rotating shaft according to the first embodiment of the present invention;

FIG. 6A is a structure diagram of components according to a second embodiment of the present invention;

FIG. 6B is a cross-sectional view of a trigonal shaft bushing according to the second embodiment of the present invention;

FIG. 7A is a side view of the trigonal shaft bushing according to the second embodiment of the present invention; and

FIG. 7B is a front view of the trigonal shaft bushing according to the second embodiment of the present invention.

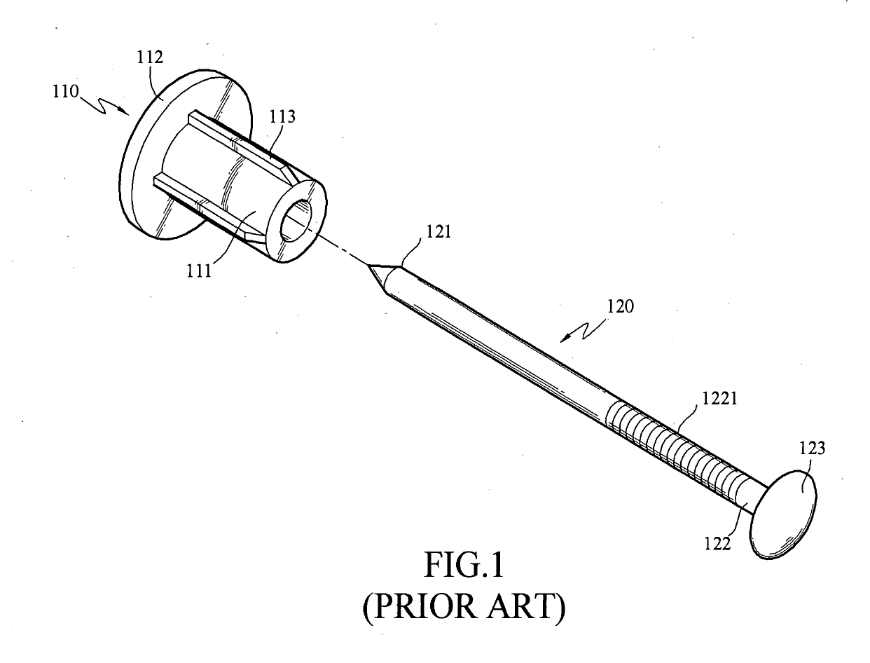

### DETAILED DESCRIPTION OF THE INVENTION

To further understand the object, structure, feature, and function of the present invention, the present invention is further described below in detail with reference to embodiments and accompanying drawings.

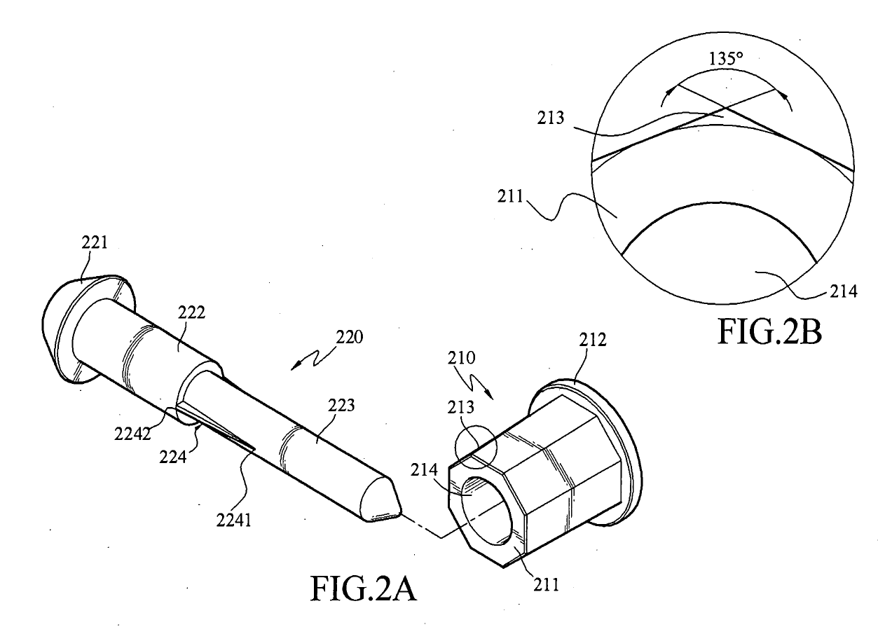

Referring to FIGS. 2A and 2B, they are a structure diagram of components and a cross-sectional view of a shaft bushing according to a first preferred embodiment of the present invention. A shaft bushing 210 and a shaft 220 are included. The shaft bushing 210 has a body 211, a flange 212, and a plurality of gripping portions 213. A shaft hole 214 is formed to pass through front and back ends of the body 211, the flange 212 is disposed on the back end of the body 211, and the gripping portions 213 are protruded from the outer edge of the body 211, and symmetrically about the shaft center of the body 211. The upper sides of the ramps of the gripping portions 213 are connected to form a top edge, the down sides are spaced apart for a predetermined distance and connected to the outer edge of the body 211, and the bottom parts of the gripping portions 213 are connected together. The angle formed between the two ramps of the gripping portions is between 60 degrees and 135 degrees, and the angle may be varied to make the shaft bushing form cylinders in different shapes such as trigonal to octagonal shapes. The shaft bushing 210 in a shape of an octagonal cylinder formed with the angle of 135 degrees is taken as an example in this embodiment.

The shaft 220 is in the shape of a conical nail, and has three parts: a shaft head 221, a shaft middle section 222, and a shaft tail 223 with their outside diameters sequentially from large to small, wherein the outside diameter of the shaft head 221 is larger than that of the aperture of the shaft hole 214, the outside diameter of the shaft middle section 222 is between the outside diameter of the shaft head 221 and that of the shaft tail 223, and the fin 224 is protruded from the outer edge of the shaft tail 223.

The maximum height of the fin 224 is between the outside diameter of the shaft middle section 222 and that of the shaft tail 223. One end portion of the fin 224 that is close to the shaft tail 223 is called a first end 2241, and the other end portion that is close to the shaft middle section 222 is called a second end 2242, wherein the width and height of the first end 2241 are smaller that that of the second end 2242. According to users' different requirements, the second end 2242 of the fin 224 is connected to the shaft middle section 222.

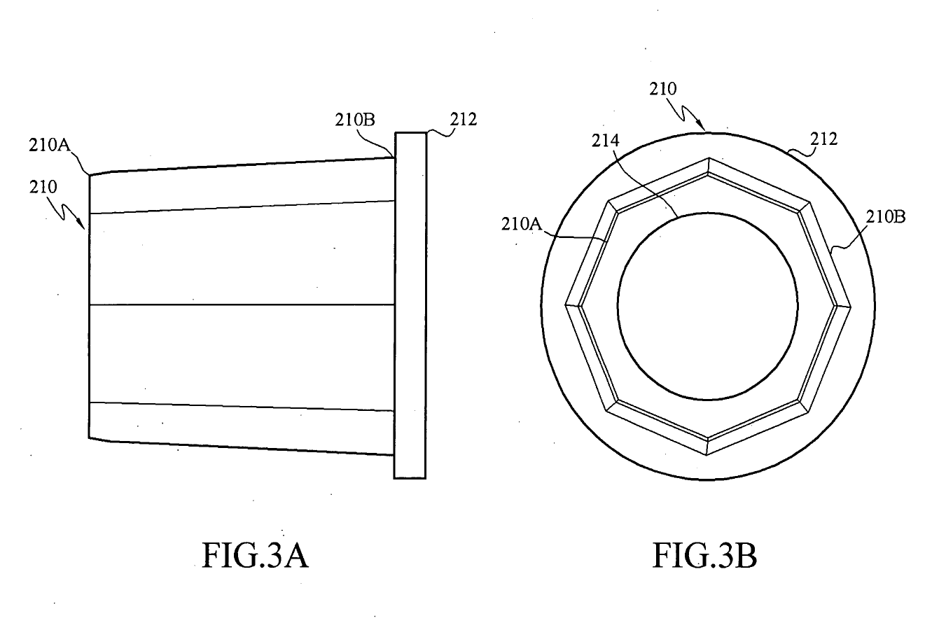

Referring to the FIGS. 3A and 3B, they are respectively a side view and a front view of a shaft bushing according to the first preferred embodiment of the present invention. As shown in the figures, the outside diameter of the front end 210A of the shaft bushing is made to be a little smaller than that of the back end 210B of the shaft bushing, so as to form a slight gradient difference. Of course, the outside diameter of the back end of the body may also be designed to be larger than that of the front end of the body so as to achieve the same effect, or the body may be adjusted, such that the shaft bushing 210 is formed into the shape and gradient as required by the user.

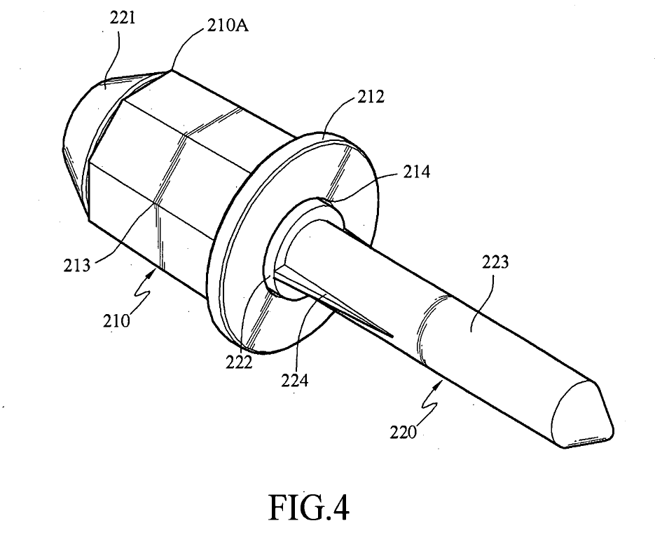

Referring to FIG. 4, it is an assembly view of a rotating shaft according to the first preferred embodiment of the present invention. The shaft 220 passes through and is accommodated within the shaft bushing 210, with the shaft head 221 bearing against the outer edge of the front end of the shaft bushing 210A, the shaft middle section 222 being accommodated within the shaft hole 214, and the shaft tail 223 protruding from the back end of the shaft bushing 210B.

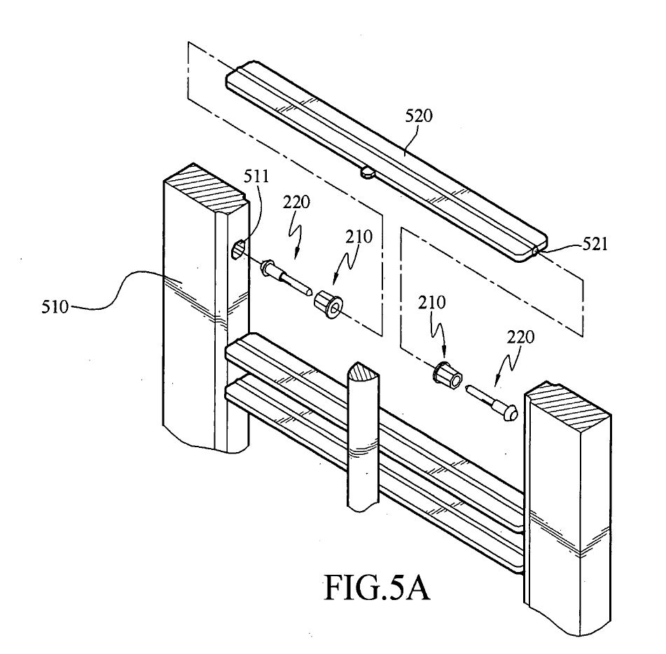

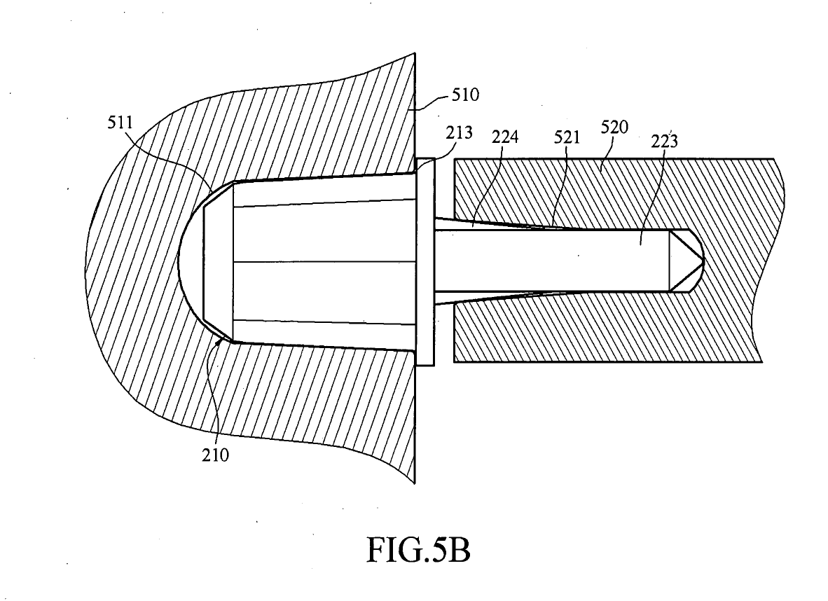

Referring to FIGS. 5A and 5B, they are respectively an assembly view of connecting the louver to the frame and a cross-sectional view of the connection according to the first preferred embodiment of the present invention. The shaft bushing 210 and the shaft 220 are combined to form a rotating shaft, and they are respectively inserted into the frame mounting hole 511 of the frame 510 and the louver mounting hole 521 of the louver 520. At this time, the gripping portion 213 bears against the inner side of the frame mounting hole 511, and the gradient design of the ramps of the gripping portion 213 enhances the force for bearing against the frame mounting hole 511, thus fixing the shaft bushing 210. Furthermore, such gradient design prevents the changing of the aperture of the frame mounting hole 511 as a result of the heat expand and cold contract effect of the frame 510, which causes that the shaft bushing 210 cannot be sleeved.

As described above, the outside diameter of the front end 210A of the shaft bushing is made to be smaller than that of the back end 210B of the shaft bushing, thus, when the frame mounting hole 511 is opened, its aperture is set to be between the outside diameters of the front and back ends of the shaft bushing 210. Therefore, even if the aperture of the frame mounting hole 511 contracts or expands as a result of the frame 510 being heated or cooled, the aperture does not exceed the range between the outside diameters of the front and back ends of the shaft bushing 210, thus, the shaft bushing 210 still can be easily inserted into the frame mounting hole 511.

The shaft tail 223 is inserted into the louver mounting hole 521 of the louver 520, and at this time, the fin 224 bears against the outer edge of the louver mounting hole 521, so as to enhance the effect of fixing the louver 520. The louver 520 is fixed and positioned on the frame 510 by using the two fixing methods together.

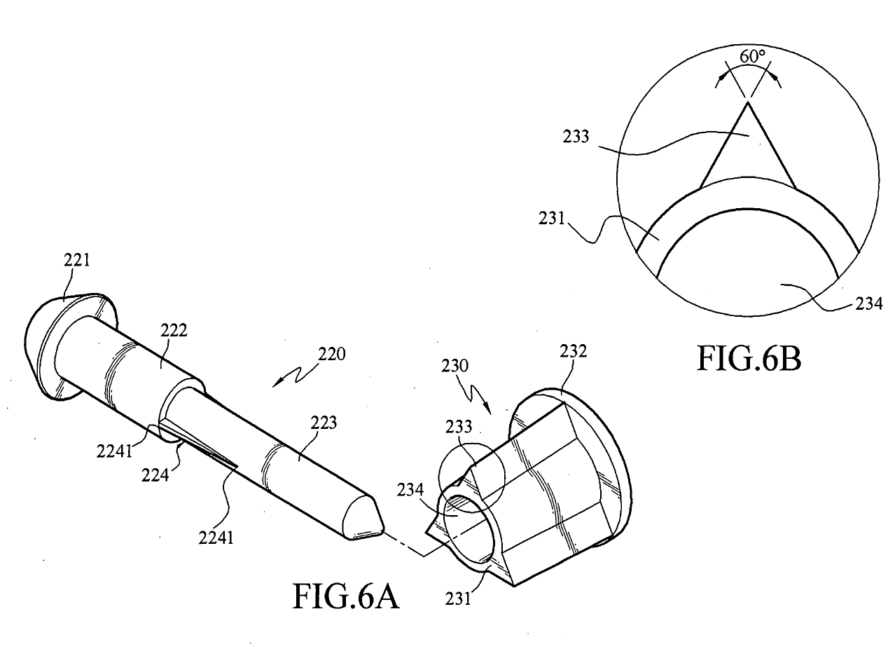

Referring to FIGS. 6A and 6B, they are structure diagrams of components according to a second embodiment of the present invention. A trigonal shaft bushing 230 and a shaft 220 are included, wherein the shaft 220 also passes through and is accommodated within the trigonal shaft bushing 230. The trigonal shaft bushing 230 includes a trigonal shaft bushing body 231, a trigonal shaft bushing flange 232, a plurality of trigonal gripping portions 233, and a shaft hole 234 of the trigonal shaft bushing. In this embodiment, the top portions of the two ramps of trigonal gripping portions 233 are connected to form an angle of 60 degrees, and the trigonal gripping portions 233 are protruded from the outer edge of the middle section of the trigonal shaft bushing body 231 and symmetrically about the shaft center of the trigonal shaft bushing body 231.

However, the difference from the shaft bushing 210 shown in FIG. 2A lies in that: the bottom parts of the trigonal gripping portion 233 are not connected. From the appearance, it is similar to the conventional way of disposing the fin, but the effect that is produced is quite different. Generally, when the fin is disposed, from the cross-sectional view, the top and bottom parts are of the same width, which is quite small, so the fin is easily cracked under an external force. However, the cross-section of this trigonal gripping portion 233 is wedge-shaped, and when the top edge bears against the inner side of the frame mounting hole 511, the force is distracted from the ramp of the trigonal gripping portion 233 to the trigonal shaft bushing body 231. Then, the cylindrical shape of the trigonal shaft bushing body 231 is utilized to distract and counteract the force transferred by each trigonal gripping portion 233. Furthermore, the bottom part of the trigonal gripping portion 233 is connected to the trigonal shaft bushing body 231 and has a width being much larger than that of the top edge. Even if the side surface is applied with an external force, the external force can be distracted via the gradient design of the trigonal gripping portion 233, thus, the trigonal gripping portion 233 is not easily deformed, cracked, or abrased.

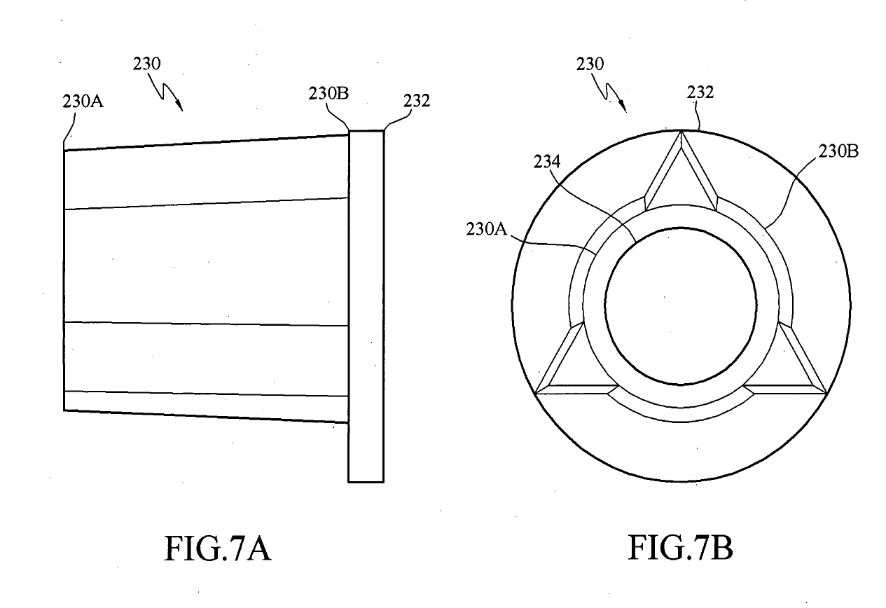

Referring to FIGS. 7A and 7B, they are a side view and a front view of the trigonal shaft bushing according to the second embodiment of the present invention. As shown in the figures, the outside diameter of the front end 230A of the trigonal shaft bushing is also made to be a little smaller than that of the back end 230B of the trigonal shaft bushing, so as to form a slight gradient difference. As seen from the perspective of the front end of the trigonal shaft bushing 230, the trigonal gripping portion 233 is shaped like a gradually ascending hillside. As described above, this design is used to prevent the changing of the aperture of the frame mounting hole 511 as a result of the heat expand and cold contract, which causes that the shaft bushing cannot be sleeved, and the gradient design of the trigonal gripping portion 233 can be used to distract the force produced by bearing against the inner side of the frame mounting hole 511. However, the user also can adjust the trigonal shaft bushing body, such that the trigonal shaft bushing 230 forms into the required shape and gradient.

By utilizing the rotating shaft of the present invention, not only the frame mounting hole is prevented from being damaged due to the poor fixing effect of the rotating shaft, but also the louver is positioned on the frame of the shutter quickly and firmly, and it is convenient for both mounting and detaching, so as to simplify the assembling process and enhance the production efficiency, thus having obvious advantage and great practical value.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rotating shaft of a shutter louver, connected between a shutter louver and a frame, comprising:
a shaft bushing, having a body, a flange, and a plurality of gripping portions, wherein a shaft hole passes through front and back ends of the body; the flange is disposed on an outer edge of the back end of the body; and each of the gripping portions is protruded from the outer edge of a middle section of the body, and symmetrically about a shaft center of the body, and each of the gripping portions has two ramps with upper sides being connected to form a top edge, and with down sides being spaced apart for a predetermined distance and respectively connected to the outer edge of the body, thus, a cross-section of each of the gripping portions is wedge-shaped; and
a shaft, having a shaft body passing through and being accommodated within the shaft hole, wherein an outside diameter of a head of the shaft is larger than that of an aperture of the shaft hole, an outside diameter of a middle section of the shaft is between the outside diameter of the shaft head and that of a tail of the shaft, and at least one fin is protruded from the outer edge of the shaft tail.

2. The rotating shaft of a shutter louver as claimed in claim 1, wherein the maximum height of the fin is between the outside diameter of the shaft middle section and that of the shaft tail.

3. The rotating shaft of a shutter louver as claimed in claim 1, wherein an angle of the two ramps on each of the gripping portions is between 60 degrees and 135 degrees.

4. The rotating shaft of a shutter louver as claimed in claim 1, wherein bottom parts of the adjacent gripping portions are connected with each other.

5. The rotating shaft of a shutter louver as claimed in claim 1, wherein the outside diameter of the back end of the shaft bushing is larger than that of the front end of the shaft bushing.

6. The rotating shaft of a shutter louver as claimed in claim 1, wherein the outside diameter of the back end of the body is larger than that of the front end of the body.

7. The rotating shaft of a shutter louver as claimed in claim 1, wherein the width and height of a first end of the fin that is close to the shaft tail are smaller than that of a second end that is close to the shaft middle section.

8. The rotating shaft of a shutter louver as claimed in claim 7, wherein the maximum height of the fin is between the outside diameter of the shaft middle section and that of the shaft tail.

9. The rotating shaft of a shutter louver as claimed in claim 8, wherein the fin adjoins with the shaft middle section via the second end.
